(19) United States
(12) Patent Application Publication
(10) Pub. No.: US 2012/0043846 A1
(43) Pub. Date: Feb. 23, 2012

(54) MOTOR WITH IMPEDANCE BALANCED WINDING

(75) Inventors: Daniel R. Wolfington, Florissant, MO (US); Joey M. Bomar, Glen Carbon, IL (US); Sean P. McCloskey, O'Fallon, MO (US)

(73) Assignee: EMERSON ELECTRIC CO, St. Louis, MO (US)

(21) Appl. No.: 12/861,664

(22) Filed: Aug. 23, 2010

(51) Int. Cl. H02K 3/28; H02K 15/085

(52) U.S. Cl. 310/195; 29/596

(57) ABSTRACT

A three-phase electric motor assembly is configured to include phase windings that are substantially equally distributed between radially inner portions and radially outer portions within axial slots of a stator core. At least two of the phase windings each include radial inner portions within selected slots and radial outer portions within other slots, such that each of the radial inner portions is positioned within a slot radially inward from the radial outer portion of another of the phase windings, and each of the radial outer portions is positioned within a slot radially outward from the radial inner portion of another of the phase windings. The motor assembly provides balanced impedance between the phase windings to minimize losses attributed to inter-phase circulating currents, increasing overall motor efficiency. The arrangement of the phase windings configures the winding for more direct exposure of at least a part of each phase winding to a cooling system for enhanced heat rejection from end coils. Methods for inserting partial phase windings that can be mechanically executed are also provided.

### BACKGROUND OF THE INVENTION

1. Field of the Invention

The present invention relates generally to a three-phase, electric motor assembly. More specifically, aspects of the present invention concern a three-phase, electric motor assembly that includes phase winding portions that are disposed within a stator core assembly to balance impedance, increase motor efficiency, and provide for mechanized insertion of the phase winding portions.

2. Discussion of the Prior Art

Those of ordinary skill in the art will appreciate that three-phase electric motors are known to be generally effective and are commonly used in a variety of industrial applications. For example, three-phase electric motors may be used to power industrial machinery, such as a drive system in a track-type tractor, among other things. Three-phase electric motors include at least three distinct phase windings, commonly referred to, and readily understood by one of ordinary skill in the art, as A-phase, B-phase, and C-phase windings.

Conventionally, the A-phase, B-phase, and C-phase windings are inserted within axial slots of a stator core assembly. One known technique for inserting the phase windings into the stator core assembly is lap winding, wherein an individual coil of wire comprising a number of turns is inserted into a selected pair of slots within the stator core assembly. Subsequent individual coils of wire are then inserted into adjacent pairs of slots within the stator core assembly, such that the coils overlap in a “shingled” arrangement. Lap winding is known to be generally effective in some ways, but the coils must be manually inserted and manipulated by hand This is a time-consuming and labor-intensive process that can be detrimental to large-scale production.

In order to facilitate large-scale production, phase windings have been inserted into the stator core assembly by machine, in an attempt to approximate the structure provided by manual lap winding. In a conventional machine-insertion technique, the coils of wire comprising each phase winding have been inserted in sequential order. In this way, the entire A-phase winding is inserted into selected ones of the slots within the stator core assembly first. Next, the entire B-phase winding is inserted into selected ones of the slots within the stator core assembly second. Finally, the entire C-phase winding is inserted into selected ones of the slots within the stator core assembly last.

While known machine-insertion techniques have been satisfactory in some respects, notably in that increased production can be realized, such machine-insertion techniques have also presented drawbacks in the structure of the total winding. For example, the variance in axial disposition between the phase windings created by sequential order insertion results in an impedance imbalance between the phases across an air gap between the rotor and the stator. Such an impedance imbalance detrimentally impacts overall efficiency of the motor and can create an inability to meet high efficiency demands.

In addition, the relative radially outer disposition of the first-inserted A-phase compared to the relative radially inner disposition of the last-inserted C-phase presents drawbacks in cooling performance. Since cooling systems for the phase windings, such as an oil spray, are frequently disposed along a radially outer margin of the total winding, the radially inner portion of the total winding tends to get hotter during operation than the radially outer portion of the total winding. Because all of the last-inserted C-phase is disposed along the radially inner portion of the total winding, this phase winding often runs hotter than the other phase windings. When the radially inner C-phase runs hotter, this phase ages faster and may create hot spots that can lead to premature failure of the motor, it may operate at a temperature over the induction class limit, and it may exhibit increased resistance within the phase and lead to further impedance imbalance.

Those of ordinary skill in the art will appreciate that known winding insertion techniques have essentially required a choice to be made between the increased performance but higher cost and low production capabilities of lap winding, and the impedance imbalance but higher production capabilities of known machine-insertion methods. Even with high volume production requirements, it remains undesirable to suffer an efficiency loss and a thermal performance detriment of known machine-insertion methods, especially when trying to meet high efficiency demands.

### SUMMARY

According to an aspect of the present invention, an inventive machine-insertion technique has been developed that more closely resembles the structure provided by lap winding in a three-phase electric motor. The new insertion technique yields a motor with more balanced impedance, increased efficiency, and provides for mechanized insertion of phase winding portions for high production capabilities. The structure from the inventive insertion technique also results in better thermal performance of the motor, since at least a portion of each phase winding is disposed along both radially outer and radially inner portions of the total winding. Such an arrangement of the phase windings more directly exposes at least a portion of each phase winding to a cooling system for the phase windings, such as a cooling oil spray.

According to one aspect of the present invention, a three-phase electric motor assembly is provided. The motor assembly includes a stator core that presents circumferentially spaced axial slots and that defines a central bore for receiving a rotor configured to rotate about an axis. The motor assembly also includes a first phase winding that is received within and distributed generally across multiple ones of the axial slots of the stator core, a second phase winding that is received within and distributed generally across multiple ones of the axial slots of the stator core, and a third phase winding that is received within and distributed generally across multiple ones of the axial slots of the stator core. At least two of the phase windings each include radial inner portions within selected ones of the axial slots and radial outer portions within selected others of the axial slots. Each of the radial inner portions of the phase windings is positioned within the corresponding axial slot radially inward from the radial outer portion of another one of the phase windings. Each of the radial outer portions of the phase windings is positioned within the corresponding axial slot radially outward from the radial inner portion of another one of the phase windings.

According to another aspect of the present invention, a method of assembling components for a three-phase electric motor is provided, wherein the motor includes a stator core that presents circumferentially spaced axial slots and that defines a central axial bore for receiving a rotor configured to rotate about an axis. The method includes the steps of inserting initial portions of a first phase winding and a second phase winding into selected ones of the axial slots, such that the initial portions cooperatively define a part of a radially outermost margin of a generally axially concentric winding, and inserting a third phase winding into selected ones of the axial slots. At least some of the slots into which the third phase winding is inserted include the initial portions of the first and second phase windings, such that the portions of the third phase winding disposed in those slots are disposed radially inwardly from the initial portions of the first and second phase windings. The method also includes the step of inserting remaining portions of the first phase winding and the second phase winding into selected others of the axial slots, such that the remaining portions cooperatively define a part of a radially innermost margin of the generally axially concentric winding.

Another aspect of the present invention concerns a method of placing phase windings into a stator core for a three-phase electric motor to optimize impedance balancing, wherein the stator core presents circumferentially spaced axial slots and defines a central axial bore for receiving a rotor configured to rotate about an axis. The method includes the steps of inserting an initial portion of a first phase winding into selected ones of the axial slots, such that the initial portion of the first phase winding defines a part of a radially outermost margin of a generally axially concentric winding, and inserting an initial portion of a second phase winding into selected others of the axial slots, such that the initial portion of the second phase winding defines another part of the radially outermost margin of the generally axially concentric winding. The method also includes the steps of inserting an initial portion of a third phase winding into selected ones of the axial slots, such that at least some of the slots into which the initial portion of the third phase is inserted include one of the initial portion of the first phase winding and the initial portion of the second phase winding, to thereby define a part of a radially innermost margin of the generally axially concentric winding, and inserting a remaining portion of the third phase winding into selected others of the axial slots, such that at least some of the slots into which the remaining portion of the third phase is inserted include the other of the initial portion of the first phase winding and the initial portion of the second phase winding, to thereby define another part of the radially innermost margin of the generally axially concentric winding. The method also includes the steps of inserting a remaining portion of the first phase winding into selected ones of the axial slots, such that at least some of the slots into which the remaining portion of the first phase is inserted include the initial portion of the second phase winding, to thereby define another part of the radially innermost margin of the generally axially concentric winding, and inserting a remaining portion of the second phase winding into selected others of the axial slots, such that at least some of the slots into which the remaining portion of the second phase is inserted include the initial portion of the first phase winding, to thereby define another part of the radially innermost margin of the generally axially concentric winding.

This summary is provided to introduce a selection of concepts in a simplified form that are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is a partial cutaway isometric view of a three-phase, electric induction motor assembly constructed in accordance with the principles of an embodiment of the present invention, illustrating a rotor assembly and a stator core assembly disposed within a motor case that includes opposite endshields, and a shaft partially extending through one of the endshields, depicting in detail internal components of the motor assembly including the stator core assembly comprising a plurality of axially stacked stator laminations presenting axial slots;

FIG. 2 is a generally schematic winding distribution diagram of a portion of a prior art three-phase motor, illustrating a stator core assembly with phase windings received within selected ones of the axial slots, and depicting relative dispositions of each of the phase windings with respect to one another;

FIG. 3a is a schematic phase winding insertion diagram, illustrating a winding insertion step for the prior art motor of FIG. 2, depicting winding coils to be inserted during a first insertion step wherein all of the A-phase winding is inserted into the selected axial slots;

FIG. 3b is a schematic phase winding insertion diagram, similar in many respects to FIG. 3a, illustrating a subsequent winding insertion step for the prior art motor of FIG. 2, depicting winding coils to be inserted during a second insertion step wherein all of the B-phase winding is inserted into the selected axial slots after placement of all of the A-phase winding;

FIG. 3c is a schematic phase winding insertion diagram, similar in many respects to FIGS. 3a and 3b, illustrating a subsequent winding insertion step for the prior art motor of FIG. 2, depicting winding coils to be inserted during a third insertion step wherein all of the C-phase winding is inserted into the selected axial slots after placement of all of the A-phase and B-phase winding;

FIG. 4 is a generally schematic winding distribution diagram of a portion of a three-phase electric induction motor constructed in accordance with the principles of a preferred embodiment of the present invention, such as the motor assembly of FIG. 1, illustrating a stator core assembly with initial portions of the A-phase and C-phase windings received within selected ones of the axial slots, and depicting relative dispositions of each of the portions of the phase windings with respect to one another;

FIG. 5 is a generally schematic winding distribution diagram of the portion of the three-phase electric induction motor shown in FIG. 4, illustrating the stator core assembly with the B-phase winding received within selected ones of the axial slots such that some portions of the B-phase winding are disposed radially inwardly from some of the initial portions of the A-phase winding and other portions of the B-phase winding are disposed radially inwardly from some of the initial portions of the C-phase winding, and depicting relative dispositions of each of the portions of the phase windings with respect to one another;

FIG. 6 is a generally schematic winding distribution diagram of the portion of the three-phase electric induction motor shown in FIGS. 4 and 5, illustrating the stator core assembly with remaining portions of the A-phase and C-phase windings received within selected others of the axial slots such that some portions of the remaining A-phase and C-phase windings are disposed radially inwardly from some of the portions of the B-phase winding, and depicting relative dispositions of each of the portions of the phase windings with respect to one another;

FIG. 7a is a schematic phase winding insertion diagram, illustrating a winding insertion step for a three-phase electric induction motor constructed in accordance with the principles of a preferred embodiment of the present invention, such as the motor assembly of FIG. 1, depicting winding coils to be inserted during first insertion steps wherein initial portions of the A-phase and C-phase windings are inserted into the selected axial slots such that the stator core assembly following these insertion steps corresponds in many ways with the diagram shown in FIG. 4;

FIG. 7b is a schematic phase winding insertion diagram, similar in many respects to FIG. 7a, illustrating a subsequent winding insertion step for the three-phase electric induction motor, depicting winding coils to be inserted during second insertion steps wherein the B-phase winding is inserted into the selected axial slots such that the stator core assembly following these insertion steps corresponds in many ways with the diagram shown in FIG. 5; and

FIG. 7c is a schematic phase winding insertion diagram, similar in many respects to FIGS. 7a and 7b, illustrating a subsequent winding insertion step for the three-phase electric induction motor, depicting winding coils to be inserted during third insertion steps wherein remaining portions of the A-phase and C-phase windings are inserted into the selected axial slots such that the stator core assembly following these insertion steps corresponds in many ways with the diagram shown in FIG. 6.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION OF THE PREFERRED EMBODIMENTS

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

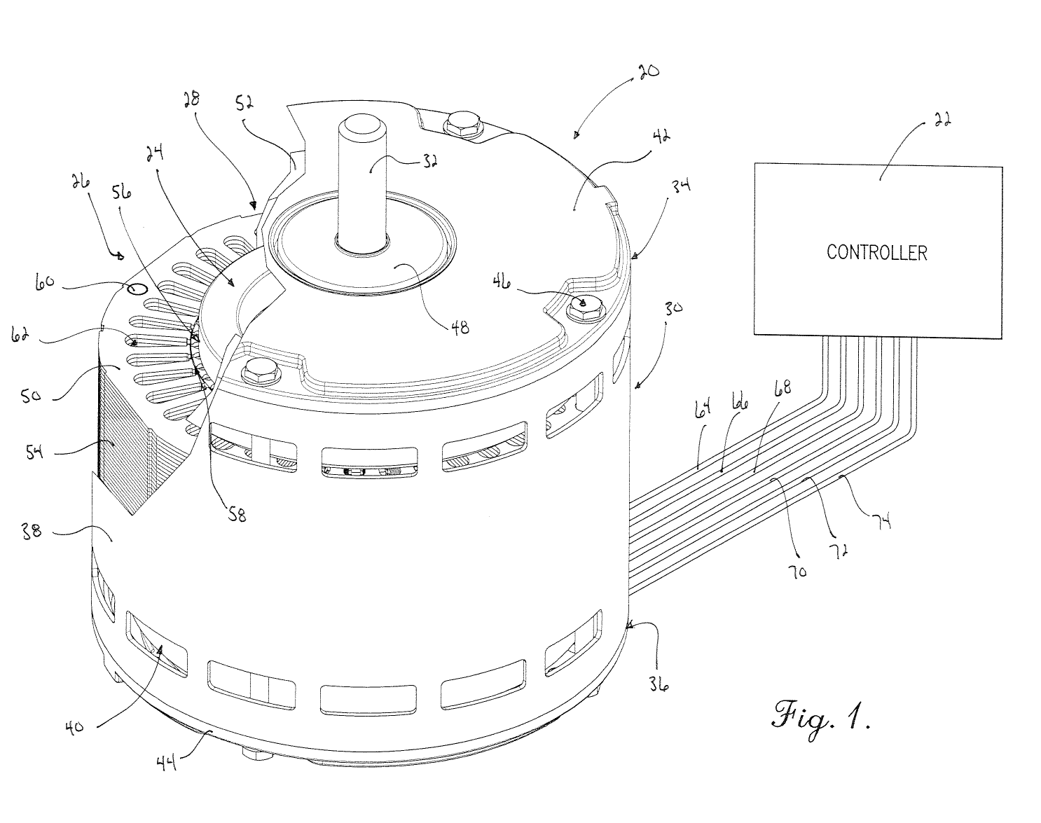

With initial reference to FIG. 1, a three-phase, electric induction motor assembly 20 constructed in accordance with the principles of an embodiment of the present invention is depicted for use in various applications. While the motor assembly 20 is useful in various applications, the illustrated embodiment has particular utility when the motor assembly 20 is configured to power industrial machinery. More specifically, the motor assembly 20 may include a digital controller 22, and is notably advantageous when the motor assembly 20 is configured to power a drive system in a track-type tractor (not shown).

It is noted that in an industrial application, the digital controller 22 may be a separable component of the motor assembly 20 (as depicted), or may be integrated into either the motor assembly 20 or the device to be driven thereby without departing from the teachings of the present invention. Moreover, it is specifically noted that the motor assembly 20 need not take the form of an induction motor assembly (as shown in FIG. 1), as various aspects of the present invention may also apply to switch reluctance and/or permanent magnet motor assemblies, as will be readily appreciated by one of ordinary skill in the art upon review of this disclosure.

As is generally customary, the motor assembly 20 broadly includes a rotor assembly 24, which is rotatable about an axis 25, and a stator assembly 26. The rotor assembly 24 and the stator assembly 26 are both generally contained within an internal motor chamber 28 that is broadly defined by a motor case 30. The rotor assembly 24 includes an axially disposed shaft 32 that projects outwardly from one end of the motor case 30.

The illustrated motor case 30 is generally cylindrical and presents opposite axial margins 34, 36. The motor case 30 comprises a shell element 38 that includes a plurality of vent openings 40 disposed around a radially outer margin of the shell 38 to present a vented shell 38. It will be readily appreciated by one of ordinary skill in the art, however, that the alternative use of a non-vented shell (not shown) is clearly within the ambit of the present invention. The motor case 30 further comprises endshields 42, 44 disposed adjacent the axial margins 34, 36, respectively, and secured to the shell 38. In the illustrated embodiment, each endshield 42, 44 is secured to the shell 38 with a plurality of fasteners comprising bolt-and-nut assemblies 46. It will be readily appreciated by one of ordinary skill in the art, however, that either or both of the endshields 42, 44 could be alternatively secured to the shell 38, such as by welding or being integrally formed therewith, without departing from the teachings of the present invention.

With continued reference to FIG. 1, it is noted that the endshields 42, 44 are substantially similar in many respects, with the notable exception that the endshield 42 is predominantly solid, while the endshield 44 (not depicted in detail) includes a plurality of vent openings (not shown) defined therethrough. Such vent openings may permit vent air to flow in a generally axial direction from outside to inside the motor chamber 28 to cool the motor assembly 20 from heat generated during operation. As will be readily appreciated by one of ordinary skill in the art upon review of this disclosure, a fan (not shown) configured for rotation with the rotor assembly 24 may be used to pull cooling vent air through the vent openings, into the motor chamber 28, and push the air out of the vent openings 40 in the shell 38 in order to provide a cooling effect to the motor assembly 20.

While only one exemplary embodiment is depicted here, of course alternative cooling and/or venting arrangements, including a totally enclosed motor having a non-vented shell (not shown) and endshields without vent openings (such as the solid endshield 42), are contemplated and are clearly within the ambit of the present invention. Such alternative embodiments may include generally conventional cooling systems without departing from the teachings of the present invention. In one specific example, a totally enclosed motor having a non-vented shell and endshields without vent openings may include a cooling system comprising an oil spray, as will be readily appreciated by one of ordinary skill in the art.

As will be readily understood by one of ordinary skill in the art, a bearing assembly (not shown) is operably associated with a portion of each endshield 42, 44 for rotatably supporting the shaft 32. Additionally, a cover 48 is operably secured to a portion of the endshield 42 to substantially separate the internal motor chamber 28 from outside elements. The cover 48 includes a hole extending therethrough to surround and facilitate passthrough of the shaft 32. It is noted that a predominantly solid cover (not shown) is similarly operably secured to a portion of the endshield 44, but without facilitating passthrough of the shaft 32.

As will be readily appreciated by one of ordinary skill in the art upon review of this disclosure, many of the above-described general components of the motor assembly 20 are substantially conventional in nature, and various aspects of such components may take alternative forms and/or otherwise vary significantly from the illustrated embodiment without departing from the teachings of the present invention. Furthermore, it will be understood by one of ordinary skill in the art that several of the above-described general components (e.g., a shell, endshields, and/or covers) may not be included in some applications of the motor assembly 20, such as where the motor assembly 20 is a totally enclosed motor having a non-vented shell and endshields without vent openings. Any such modifications to generally conventional components of the motor assembly 20 are not intended to impact the scope of the present invention, which is defined exclusively by the claims.

Turning briefly now to construction details of the stator assembly 26, one of ordinary skill in the art will readily understand that the stator assembly 26 depicted in FIG. 1 broadly includes a stator core 50 and a generally axially concentric winding 52. The illustrated stator core 50 is comprised of a plurality of axially stacked stator laminations 54, as is generally known in the art. It is noted that the winding 52 depicted in FIG. 1 is shown in a conventional schematic form, but that additional details regarding the winding 52 are described below. As will be readily appreciated by one of ordinary skill in the art, the particular configuration of the winding 52 may directly impact the power, torque, voltage, operational speed, number of polls, etc. of the induction motor assembly 20.

As is somewhat conventional in the art, each individual stator lamination 54 includes a substantially annular steel body, such that the plurality of axially stacked stator laminations 54 forming the stator core 50 cooperatively presents a generally central axial bore 56 for receiving the rotor assembly 24. As will be readily understood by one of ordinary skill in the art, an air gap 58 extends radially between the stator core 50 of the stator assembly 26 and the rotor assembly 24, such that the rotor assembly 24 is able to rotate freely within the stator assembly 26. The plurality of axially stacked stator laminations 54 forming the stator core 50 also cooperatively presents a plurality of holes 60 extending axially therethrough, such that the bolt-and-nut assemblies 46 are passed through the holes 60 upon construction of the motor assembly 20.

Additionally, the plurality of axially stacked stator laminations 54 forming the stator core 50 further cooperatively presents a plurality of generally arcuate slots 62 extending axially therethrough, with each depicted slot 62 being in communication with the air gap 58. As will be readily understood by one of ordinary skill in the art, wires comprising the winding 52 pass through the slots 62 for receipt therein. It is noted that in the illustrated embodiment, the stator core 50 of the stator assembly 26 includes forty-eight slots 62, although various numbers of slots may be alternatively provided without departing from the teachings of the present invention.

The rotor assembly 24 need not be described in detail herein, with it being sufficient for the understanding of one of ordinary skill in the art to note that the rotor assembly 24 may be of conventional construction as is generally known in the art. For example, the rotor assembly 24 may comprise an exposed bar, squirrel cage rotor, although one of ordinary skill in the art will readily appreciate that various configurations of rotor assemblies may be provided while remaining within the ambit of the present invention.

Shifting now to operation considerations of three-phase motors, and to details of the winding used therein, one of ordinary skill in the art will readily appreciate that three-phase electric induction motors are commonly used in a variety of industrial applications (such as to power a drive system in a track-type tractor, among other things). As is generally known, a three-phase motor is often more compact and can be less costly than a single-phase motor of the same voltage class and duty rating. In addition, many three-phase motors often exhibit less vibration and may therefore last longer than corresponding single-phase motors of the same power used under the same conditions.

Three-phase electric induction motors can be configured to operate multiple speeds, which may be desirable in certain applications where the load is to be driven at different speeds based upon operational requirements. In the exemplary embodiment described herein, the discussion will focus on a single-speed motor. The principles of the present invention, however, are not limited to a single-speed motor, but may alternatively be applied to a two-speed motor or a motor that includes additional operating speed modes.

If desired, a common way to change operating speed modes within a three-phase motor involves changing the number of effective poles that are generated for each operating speed mode. For the exemplary embodiment described herein, the three-phase, single-speed electric induction motor assembly 20 is configured as a 4n-pole motor, where n is an integer greater than or equal to one. More specifically, the detailed discussion herein focuses on an embodiment where n is equal to one, such that the motor assembly 20 is configured as a 4-pole motor. Such an exemplary embodiment, however, is not limiting on the principles of the present invention, as other integer values of n, corresponding to higher or lower multiples of effective poles generated, remain within the ambit of the present invention.

The three-phase electric induction motor assembly 20 is driven by energizing the winding 52 with three phases of alternating current from a power source (not shown), with the phases being commonly designated as A, B, and C phases (it is noted that such conventional phase notation is used consistently herein). Each of the A, B, and C phases are essentially equal in magnitude, but are offset from one another by 120° (2π/3 radians), as will be readily understood by one of ordinary skill in the art.

By dividing the winding 52 into at least one winding coil group for each phase—here, into four (4) groups of winding coil groups corresponding with each phase in the depicted 4-pole motor—the three offset A, B, and C phases cooperatively create a rotating magnetic field within the stator assembly 26. In the three-phase electric induction motor assembly 20 depicted herein, the rotating magnetic field within the stator assembly 26 induces a corresponding rotating magnetic field within the rotor assembly 24, thereby causing rotation of the rotor assembly 24, as will be readily understood by one of ordinary skill in the art.

In order to facilitate operation of the three-phase motor assembly 20, power leads of the coil groups comprising the winding 52 are connected to an appropriate controller that can connect the leads to the power source (not shown) to thereby drive the motor assembly 20. With reference to FIG. 1, in the depicted embodiment of the present invention, the winding coil groups cooperatively present six leads 64, 66, 68, 70, 72, 74 that are connected to the controller 22 to be selectively connected to the power source (not shown), as will be readily appreciated by one of ordinary skill in the art upon review of this disclosure.

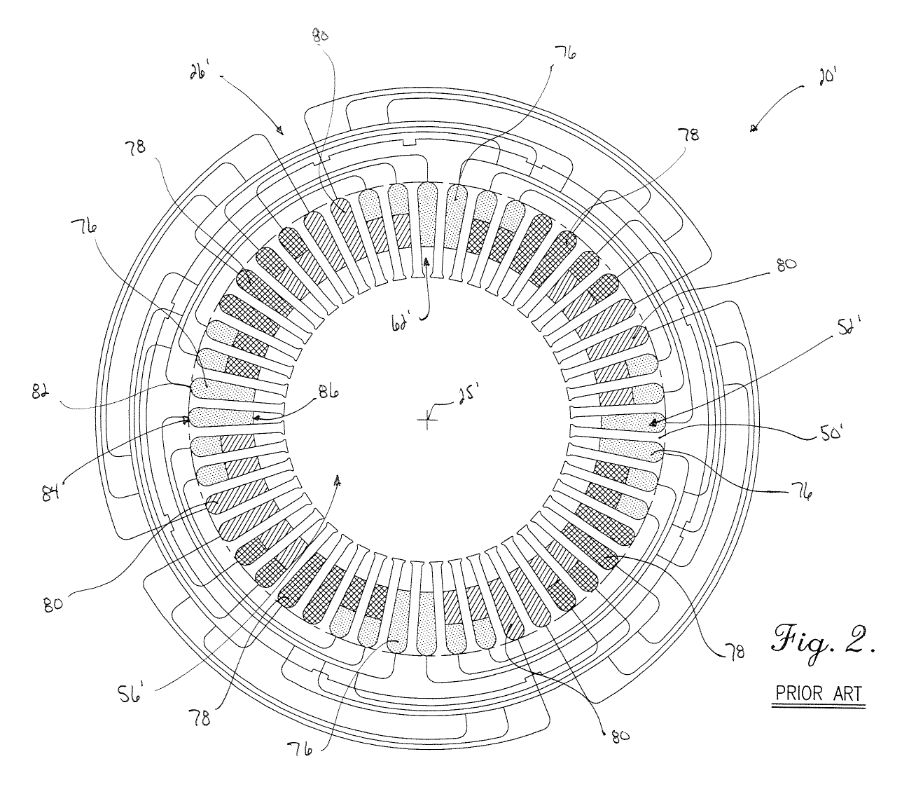

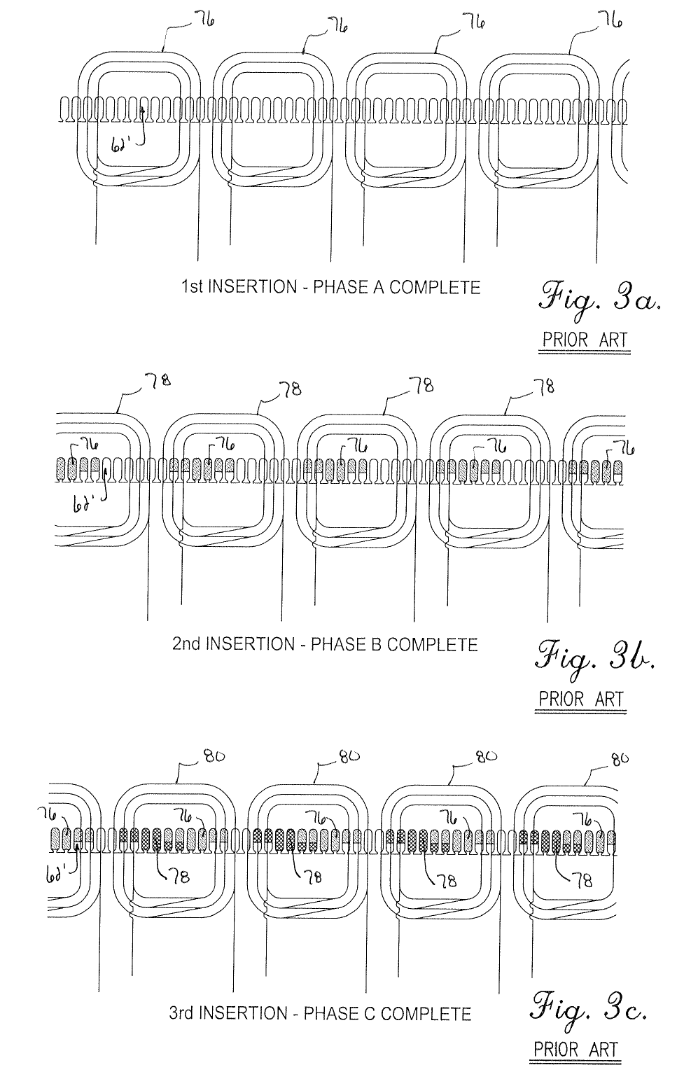

With attention first to the prior art winding distribution within a three-phase motor, schematically depicted in FIGS. 2, 3a, 3b, and 3c, a known machine-insertion technique and the resultant motor structure will be described. It is initially noted that, for the sake of brevity and convenience, certain common motor elements depicted in FIGS. 2, 3a, 3b, and 3c that may be structurally similar to those of the motor assembly 20 depicted in FIG. 1 and described above are identified by the same reference numbers as above, but include a prime to distinguish those elements shown in the figures depicting the prior art.

As can be seen in FIG. 2, a section of motor assembly 20′ depicts stator assembly 26′ including stator core 50′ presenting axial slots 62′ about central bore 56′, which contains axis 25′. Winding 52′ comprises phase windings described in detail below disposed within the slots 62′ to surround the central bore 56′, which is configured to receive a rotor assembly (not shown), as will be readily appreciated by one of ordinary skill in the art.

As is generally traditional in the art, the winding 52′ comprises A-phase winding 76, B-phase winding 78, and C-phase winding 80. The axial slots 62′ present radially outermost back portions 82, and the A-phase winding 76, B-phase winding 78, and C-phase winding 80 are all received within selected ones of the axial slots 62′. The winding 52′ presents a radially outer margin 84 and a radially inner margin 86.

From a detailed review of FIG. 2, it will be readily appreciated that some of the axial slots 62′ include parts of multiple phase windings 76, 78, 80. More specifically, some axial slots 62′ include part of an A-phase winding 76 and part of a B-phase winding 78, with the part of the A-phase winding 76 being disposed radially outwardly from the part of the B-phase winding 78. Some other axial slots 62′ include part of an A-phase winding 76 and part of a C-phase winding 80, with the part of the A-phase winding 76 being disposed radially outwardly from the part of the C-phase winding 80. Some other axial slots 62′ include part of a B-phase winding 78 and part of a C-phase winding 80, with the part of the B-phase winding 78 being disposed radially outwardly from the part of the C-phase winding 80.

It is specifically noted, however, that none of the slots 62′ that include parts of multiple phase windings 76, 78, 80 include any part of the C-phase winding 80 disposed radially outwardly from any part of either the A-phase winding 76 or the B-phase winding 78. Moreover, none of the slots 62′ that include parts of multiple phase windings 76, 78, 80 include any part of the A-phase winding 76 disposed radially inwardly from any part of either the B-phase winding 78 or the C-phase winding 80. Thus, only selected parts of the B-phase winding 78 are disposed one of radially inwardly and radially outwardly from parts of the A-phase winding 76 and parts of the C-phase winding 80.

Given the relative dispositions of the multiple phase windings 76, 78, 80 within the axial slots 62′, it is generally referenced in the art that the A-Phase winding 76 are disposed predominantly in the backs 82 of the slots 62′, that the B-Phase winding 78 are disposed in a predominantly alternating arrangement between mid-slot and the back 82 of the slots 62′, and that the C-Phase winding 80 are disposed predominantly toward the central bore 56′. Thus, the radially outer margin 84 includes mostly A-phase winding 76, while the radially inner margin 86 includes mostly C-phase winding 80.

The generally alternating positions of the multiple phase windings 76, 78, 80 from the backs 82 of the slots 62′ to toward the central bore 56′ creates imbalanced reactance within the prior art motor assembly 20′. Moreover, the coils of the multiple phase windings 76, 78, 80 are typically graded from the A-phase winding 76 to the C-phase winding 80 in order to achieve a minimum end-turn package, as will be readily appreciated by one of ordinary skill in the art upon review of this disclosure. The grading of the coils of the multiple phase windings 76, 78, 80 from the A-phase winding 76 to the C-phase winding 80 means that the coils of the A-phase winding 76 are physically longer than the coils of the C-phase winding 80. This coil grading creates imbalanced resistance within the prior art motor assembly 20′.

Turning briefly to FIGS. 3a, 3b, and 3c, sequential schematic phase winding diagrams illustrating conventional machine-insertion steps for inserting the multiple phase windings 76, 78, 80 to arrive at the winding 52′ depicted in FIG. 2 and described in detail above. As will be readily appreciated by one of ordinary skill in the art, FIG. 3a illustrates winding coils to be inserted during a first insertion step wherein all of the A-phase winding 76 is inserted into the selected axial slots 62′. Next, FIG. 3b illustrates the A-phase winding 76 disposed within the selected axial slots 62′ as described above, and further illustrates winding coils to be inserted during a second insertion step wherein all of the B-phase winding 78 is inserted into other selected axial slots 62′. Finally, FIG. 3c illustrates the A-phase winding 76 and the B-phase winding 78 both disposed within the selected axial slots 62′ as described above, and further illustrates winding coils to be inserted during a third insertion step wherein all of the C-phase winding 80 is inserted into the selected axial slots 62′.

Those of ordinary skill in the art will appreciate that the generally alternating positions of the multiple phase windings 76, 78, 80 within the slots 62′, based upon conventional machine-insertion steps as shown in FIGS. 3a, 3b, and 3c, and described in detail above, creates imbalanced reactance within the prior art motor assembly 20′. Additionally, the grading of the coils of the multiple phase windings 76, 78, 80 from the A-phase winding 76 to the C-phase winding 80 creates imbalanced resistance within the prior art motor assembly 20′. The imbalances within the prior art motor assembly 20′ detrimentally contribute to efficiency losses that can make it difficult for a manufacturer to met high customer efficiency demands while employing mechanized insertion steps to facilitate higher-volume production.

Turning briefly now to electric motor efficiency, it may be readily appreciated by one of ordinary skill in the art that an energy cost associated with the operation of an electric motor over the lifetime of the motor can amount to a significant financial burden for an end user. Thus, an improvement in overall motor efficiency, even if such an improvement is only a relatively small percentage, can result in significant savings in energy costs over the lifetime of the motor. An inventive improvement to motor design or construction resulting in an efficiency gain, therefore, may provide significant competitive advantage.

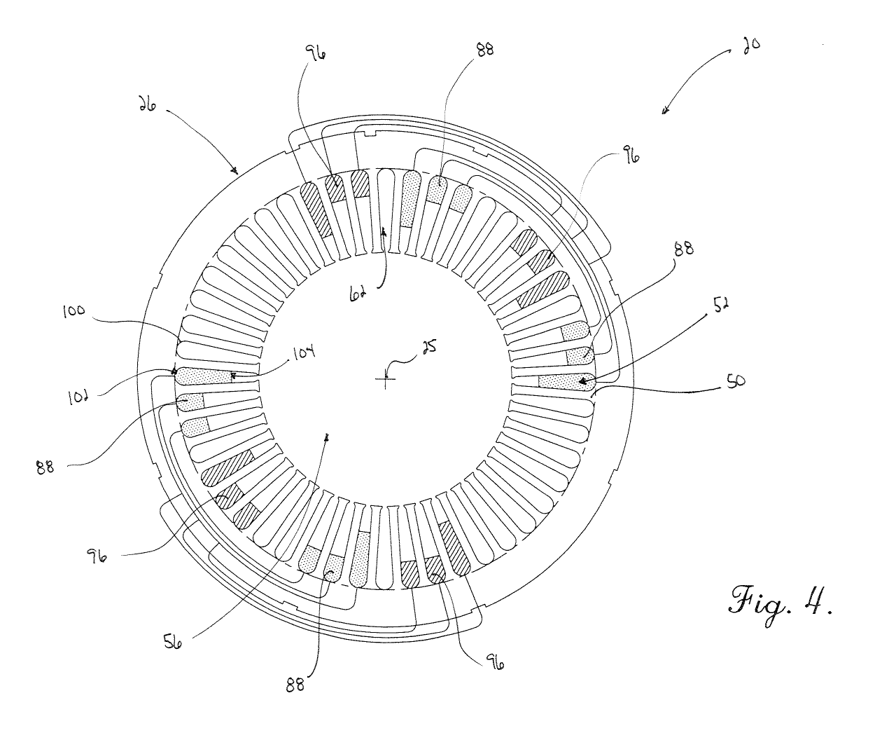

With attention specifically now to FIGS. 1 and 4-7, the inventive three-phase induction motor assembly 20 and methods of inserting phase windings to produce such a motor assembly will be described in detail. Turning first to FIGS. 4-6, a section of the motor assembly 20 depicts the stator assembly 26 including the stator core 50 presenting axial slots 62 about the central bore 56, which contains the axis 25. The winding 52 comprises phase windings described in detail below disposed within the slots 62 to surround the central bore 56, which is configured to receive a rotor assembly (not shown), as will be readily appreciated by one of ordinary skill in the art.

As is somewhat conventional in the art, the winding 52 comprises a phase winding for each of the A, B, and C phases. Unconventionally, as described in detail below, each of the phase windings for the A, B, and C phases comprises initial and remaining portions that are configured to be inserted into selected ones of the axial slots 62 separately, as will be readily appreciated by one of ordinary skill in the art upon review of this disclosure.

More specifically, the phase winding for the A phase comprises an initial portion 88 of A-phase winding and a remaining portion 90 of A-phase winding, with the respective portions 88, 90 cooperatively defining the whole A-phase winding. Similarly, the phase winding for the B phase comprises an initial portion 92 of B-phase winding and a remaining portion 94 of B-phase winding, with the respective portions 92, 94 cooperatively defining the whole B-phase winding. Finally, the phase winding for the C phase comprises an initial portion 96 of the C-phase winding and a remaining portion 98 of the C-phase winding, with the respective portions 96, 98 cooperatively defined the whole C-phase winding.

Additionally, the axial slots 62 present radially outermost back portions 100, and the A-phase winding 88, 90, the B-phase winding 92, 94, and the C-phase winding 96, 98 are all received within selected ones of the axial slots 62. The winding 52 presents a radially outer margin 102 and a radially inner margin 104.

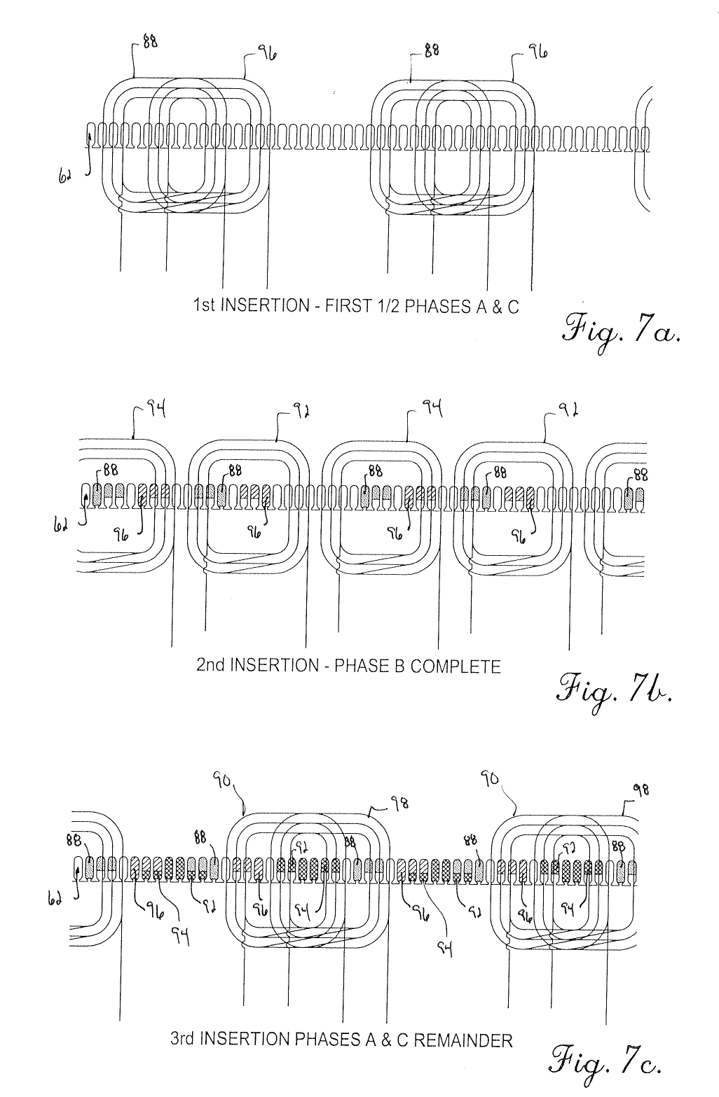

With reference first to FIGS. 4 and 7a, an initial portion 88 of the A-phase winding and an initial portion 96 of the C-phase winding are inserted during two passes of a first insertion step wherein the initial portion 88 of the A-phase winding and the initial portion 96 of the C-phase winding are inserted into the selected axial slots 62. These initial portions 88, 96 of the A-phase and C-phase windings, respectively, are disposed predominantly in the backs 100 of the slots 62. The initial portions 88, 96 of the respective A-phase and C-phase windings are received in different ones of the slots 62 from one another and cooperatively form a part of the radially outer margin 102. It is noted that in the depicted embodiment, each of the initial portions 88, 96 of the respective A-phase and C-phase windings define approximately one-half of the total of each of the respective A-phase and C-phase windings, although alternative division between the portions of the phase windings is possible without departing from the teachings of the present invention.

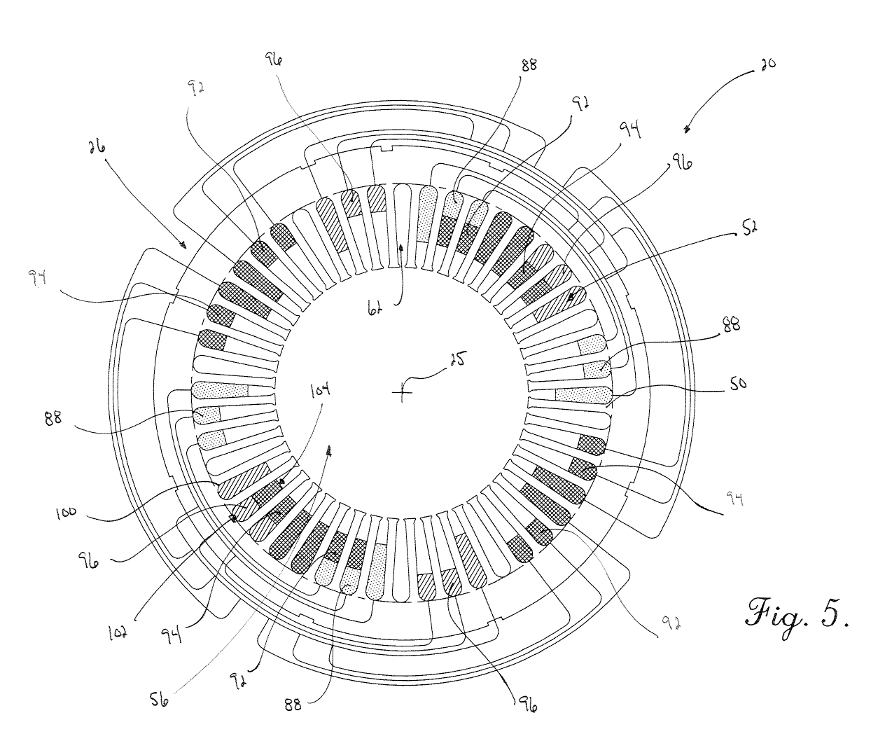

With reference next to FIGS. 5 and 7b, an initial portion 92 of the B-phase winding and a remaining portion 94 of the B-phase winding are inserted during two passes of a second insertion step wherein the initial portion 92 and the remaining portion 94 of the B-phase winding are inserted into the selected axial slots 62. Some of one of the initial and remaining portions 92, 94 of the B-phase winding is disposed within slots 62 that contain some of the initial portion 88 of the A-phase winding, and some of the other of the initial and remaining portions 92, 94 of the B-phase winding is disposed within slots 62 that contain some of the initial portion 96 of the C-phase winding. Some other of the initial and remaining portions 92, 94 of the B-phase winding is disposed within slots 62 that do not contain either of the initial portion 88 of the A-phase winding or the initial portion 96 of the C-phase winding, such that the other of the initial and remaining portions 92, 94 of the B-phase winding is disposed predominantly in the backs 100 of the previously empty slots 62.

These other of the initial and remaining portions 92, 94 of the B-phase winding disposed in the previously empty slots 62 cooperate with the initial portion 88 of the A-phase winding and the initial portion 96 of the C-phase winding to form the radially outer margin 102. It is noted that in the depicted embodiment, each of the initial and remaining portions 92, 94 of the B-phase winding defines approximately one-half of the total of the B-phase winding, although alternative division between the portions of the phase winding is possible without departing from the teachings of the present invention.

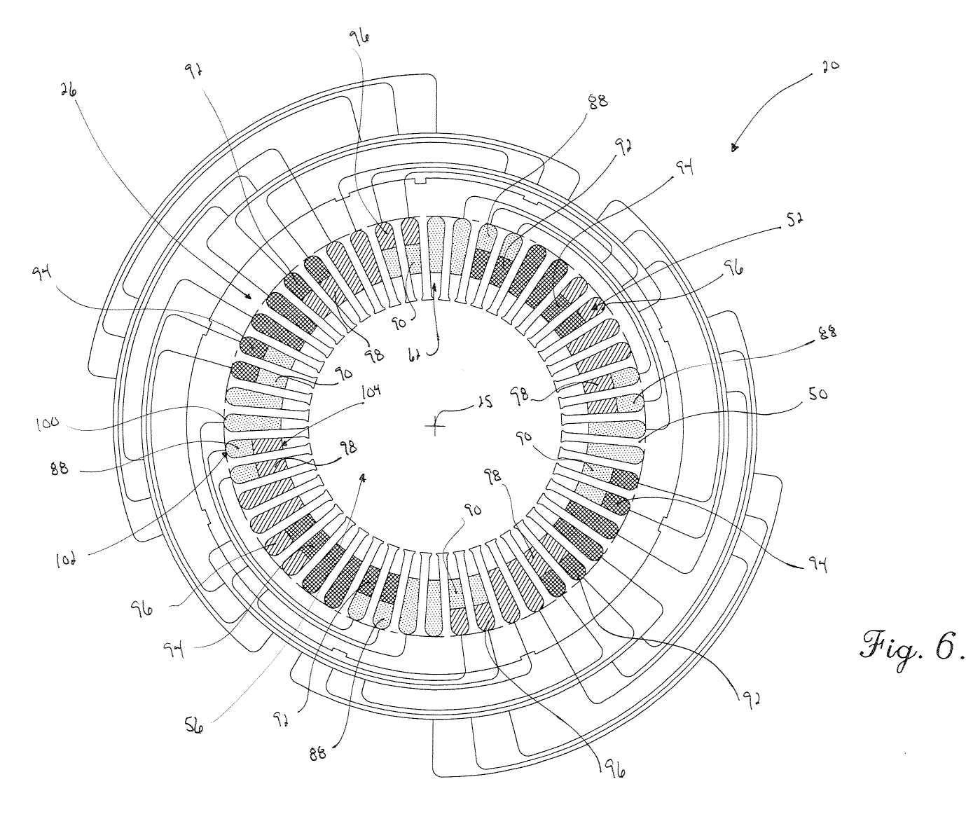

With reference next to FIGS. 6 and 7c, a remaining portion 90 of the A-phase winding and a remaining portion 98 of the C-phase winding are inserted during two passes of a third insertion step wherein the remaining portion 90 of the A-phase winding and the remaining portion 98 of the C-phase winding are inserted into the selected axial slots 62. Some of the remaining portion 90 of the A-phase winding is disposed within slots 62 that contain some of the initial portion 96 of the C-phase winding, and some of the other of the remaining portion 90 of the A-phase winding is disposed within slots 62 that contain some of one of the initial and remaining portions 92, 94 of the B-phase winding. Some of the remaining portion 98 of the C-phase winding is disposed within slots 62 that contain some of the initial portion 88 of the A-phase winding, and some of the other of the remaining portion 98 of the C-phase winding is disposed within slots 62 that contain some of one of the initial and remaining portions 92, 94 of the B-phase winding. Some other of the remaining portions 90, 98 of the respective A-phase and C-phase windings is disposed within slots 62 that do not contain any of the initial portion 88 of the A-phase winding, the initial portion 92 of the B-phase winding, the remaining portion 94 of the B-phase winding, or the initial portion 96 of the C-phase winding, such that the other of the remaining portions 90, 98 of the respective A-phase and C-phase windings is disposed predominantly in the backs 100 of the previously empty slots 62.

These other of the remaining portions 90, 98 of the respective A-phase and C-phase windings disposed in the previously empty slots 62 cooperate with the initial portion 88 of the A-phase winding, the initial portion 96 of the C-phase winding, and the other of the initial and remaining portions 92, 94 of the B-phase winding to form the radially outer margin 102. It is noted that in the depicted embodiment, each of the remaining portions 90, 98 of the respective A-phase and C-phase windings define approximately one-half of the total of each of the respective A-phase and C-phase windings, although alternative division between the portions of the phase windings is possible without departing from the teachings of the present invention.

From the sequential schematic phase winding diagrams illustrating machine-insertion steps for inserting the multiple phase windings 88, 90, 92, 94, 96, 98 shown in FIGS. 7a, 7b, and 7c, and the detailed description above, it will be appreciated that methods have been disclosed for arriving at the winding 52 depicted in FIG. 6. With continued reference to FIG. 6, it will be readily appreciated that some of the axial slots 62 include parts of multiple phase windings 88, 90, 92, 94, 96, 98.

More specifically, some axial slots 62 include part of an initial portion 88 of the A-phase winding and part of a remaining portion 94 of the B-phase winding, with the part of the initial portion 88 of the A-phase winding being disposed radially outwardly from the part of the remaining portion 94 of the B-phase winding. Some other axial slots 62 include part of an initial portion 88 of the A-phase winding and part of a remaining portion 98 of the C-phase winding, with the part of the initial portion 88 of the A-phase winding being disposed radially outwardly from the part of the remaining portion 98 of the C-phase winding.

Also, some axial slots 62 include part of an initial portion 92 of the B-phase winding and part of a remaining portion 90 of the A-phase winding, with the part of the initial portion 92 of the B-phase winding being disposed radially outwardly from the part of the remaining portion 90 of the A-phase winding. Some other axial slots 62 include part of an initial portion 92 of the B-phase winding and part of a remaining portion 98 of the C-phase winding, with the part of the initial portion 92 of the B-phase winding being disposed radially outwardly from the part of the remaining portion 98 of the C-phase winding.

Additionally, some axial slots 62 include part of an initial portion 96 of the C-phase winding and part of a remaining portion 90 of the A-phase winding, with the part of the initial portion 96 of the C-phase winding being disposed radially outwardly from the part of the remaining portion 90 of the A-phase winding. Some other axial slots 62 include part of an initial portion 96 of the C-phase winding and part of a remaining portion 94 of the B-phase winding, with the part of the initial portion 96 of the C-phase winding being disposed radially outwardly from the part of the remaining portion 94 of the B-phase winding.

It is specifically noted, therefore, that within the slots 62 that contain part of the A-phase winding 88, 90 and part of the B-phase winding 92, 94, for each slot 62 that contains the part of the initial portion 88 of the A-phase winding being disposed radially outwardly from the part of the remaining portion 94 of the B-phase winding, there is a corresponding slot 62 that contains the part of the initial portion 92 of the B-phase winding being disposed radially outwardly from the part of the remaining portion 90 of the A-phase winding.

Moreover, within the slots 62 that contain part of the A-phase winding 88, 90 and part of the C-phase winding 96, 98, for each slot 62 that contains the part of the initial portion 88 of the A-phase winding being disposed radially outwardly from the part of the remaining portion 98 of the C-phase winding, there is a corresponding slot 62 that contains the part of the initial portion 96 of the C-phase winding being disposed radially outwardly from the part of the remaining portion 90 of the A-phase winding.

Furthermore, within the slots 62 that contain part of the B-phase winding 92, 94 and part of the C-phase winding 96, 98, for each slot 62 that contains the part of the initial portion 92 of the B-phase winding being disposed radially outwardly from the part of the remaining portion 98 of the C-phase winding, there is a corresponding slot 62 that contains the part of the initial portion 96 of the C-phase winding being disposed radially outwardly from the part of the remaining portion 94 of the B-phase winding.

Given the relative dispositions of the multiple phase windings 88, 90, 92, 94, 96, 98 within the axial slots 62 described above and shown particularly in FIG. 6, it will be readily appreciated that the multiple phase windings 88, 90, 92, 94, 96, 98 are substantially balanced between the backs 100 of the slots 62 and toward the central bore 56. In more detail, each of the A-phase winding 88, 90, the B-phase winding 92, 94, and the C-phase winding 96, 98 is substantially evenly distributed in disposition between the backs 100 of the slots 62 and toward the central bore 56. More specifically, in the depicted embodiment, each of the initial portions 88, 92, 96 of the respective A-phase, B-phase, and C-phase windings defines approximately one-half of the total of each of the respective A-phase, B-phase, and C-phase windings, and each of the remaining portions 90, 94, 98 of the respective A-phase, B-phase, and C-phase windings defines approximately one-half of the total of each of the respective A-phase, B-phase, and C-phase windings, as described in detail above.

The balance within each of the multiple phase windings 88, 90, 92, 94, 96, 98 between the backs 100 of the slots 62 and toward the central bore 56, wherein each of the A-phase winding 88, 90, the B-phase winding 92, 94, and the C-phase winding 96, 98 is substantially evenly distributed in disposition between the backs 100 of the slots 62 and toward the central bore 56 balances impedance (both resistive and reactive components thereof) between the A-phase winding 88, 90, the B-phase winding 92, 94, and the C-phase winding 96, 98. Balanced impedance between the A-phase winding 88, 90, the B-phase winding 92, 94, and the C-phase winding 96, 98 minimizes losses attributed to inter-phase circulating currents, as will be readily understood by one of ordinary skill in the art. Minimizing losses attributed to inter-phase circulating currents may increase the overall efficiency of the motor assembly 20.

As noted above, the efficiency of an electric motor plays a large role in the energy cost associated with operation of the electric motor. Therefore, any improvement in overall motor efficiency, even if such improvement is only a relatively small percentage, can result in significant savings in energy costs over the lifetime of the motor, which can advantageously lower the financial burden on an end user. It is believed that the electric induction motor assembly 20 constructed in accordance with a preferred embodiment of the present invention, as described in detail above, including balance within each of the multiple phase windings 88, 90, 92, 94, 96, 98 between the backs 100 of the slots 62 and toward the central bore 56 to optimize impedance balancing, provides a notable overall gain in efficiency within the range of approximately one-half to one percent (0.5-1%) compared with prior art electric induction motor assemblies constructed by previously-known insertion techniques, such as motor assembly 20′ described above.

Moreover, the balanced multiple phase windings 88, 90, 92, 94, 96, 98, as described above, may be mechanically inserted into the slots 62, as described in detail above, with a mechanized process rather than insertion by hand The ability to insert the balanced multiple phase windings 88, 90, 92, 94, 96, 98 mechanically may lead to higher volume production and reduced labor cost compared with some conventional hand-insertion processes.

Furthermore, the coils of the balanced multiple phase windings 88, 90, 92, 94, 96, 98 are graded from a pass of the first insertion step of inserting the initial portion 88 of the A-phase winding to a pass of the third insertion step of inserting the remaining portion 98 of the C-phase winding in order to achieve a minimum end-turn package, as will be readily appreciated by one of ordinary skill in the art upon review of this disclosure. The balance within each of the multiple phase windings 88, 90, 92, 94, 96, 98 between the backs 100 of the slots 62 and toward the central bore 56, coupled with the coil grading yields balanced resistance at terminals of the motor assembly 20.

Additionally, the balance within each of the multiple phase windings 88, 90, 92, 94, 96, 98 between the backs 100 of the slots 62 and toward the central bore 56, wherein each of the A-phase winding 88, 90, the B-phase winding 92, 94, and the C-phase winding 96, 98 is substantially evenly distributed in disposition between the backs 100 of the slots 62 and toward the central bore 56 provides increased thermal performance over prior art motor assemblies. In particular, and with continued reference to FIG. 6, it will be readily appreciated that the radially outer margin 102 of the winding 52 is cooperatively formed from substantially equal parts of each of the A-phase winding 88, 90, the B-phase winding 92, 94, and the C-phase winding 96, 98. Furthermore, the radially inner margin 104 of the winding 52 is similarly cooperatively formed from substantially equal parts of each of the A-phase winding 88, 90, the B-phase winding 92, 94, and the C-phase winding 96, 98.

From the above inventive construction, substantially equal parts of all of the multiple phase windings 88, 90, 92, 94, 96, 98 are configured for exposure to a cooling system (not shown), such as fan air blown along the radially inner margin 104, cooling oil spray applied along the radially outer margin 102, or the like. By more effectively cooling substantially equal parts of all of the multiple phase windings 88, 90, 92, 94, 96, 98, the inventive construction of the motor assembly 20 described herein enhances heat rejection from end coils, which may increase reliability and service life of the motor assembly 20, as more uniform cooling among the multiple phase windings 88, 90, 92, 94, 96, 98 may reduce any premature wear on any one phase winding.

It is noted that, as is somewhat conventional in the art, phase paper (not shown) or the like may be disposed between each of the multiple phase windings 88, 90, 92, 94, 96, 98, as will be readily appreciated by one of ordinary skill in the art upon review of this disclosure. Phase paper may be particularly effective in isolating the multiple phase windings 88, 90, 92, 94, 96, 98 from one another in high-voltage motor assemblies, such as motor assemblies rated at four-hundred sixty volts (460V) and above. It is specifically noted that the inclusion or omission of phase paper within the motor assembly 20 is not intended to impact the scope of the present invention.

Finally, it is further noted that each of the A-phase winding 88, 90, the B-phase winding 92, 94, and the C-phase winding 96, 98 is described herein with particularity to correspond with the embodiment depicted in the drawings. However, as will be readily appreciated by one of ordinary skill in the art upon review of this disclosure, it may be possible to insert the multiple phase windings 88, 90, 92, 94, 96, 98 in a different order without departing from the teachings of the present invention. Therefore, the following claims recite the multiple phase windings more generally with reference to first, second, and third phase windings in the most broad recitations thereof, as will be readily understood by one of ordinary skill in the art.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and access the reasonably fair scope of the present invention as pertains to any apparatus not materially departing from but outside the literal scope of the invention set forth in the following claims.

What is claimed is:

1. A three-phase electric motor assembly, said motor assembly comprising:
a stator core presenting circumferentially spaced axial slots and defining a central bore for receiving a rotor configured to rotate about an axis;
a first phase winding received within and distributed generally across multiple ones of the axial slots of the stator core;
a second phase winding received within and distributed generally across multiple ones of the axial slots of the stator core; and
a third phase winding received within and distributed generally across multiple ones of the axial slots of the stator core,
at least two of the phase windings each including radial inner portions within selected ones of the axial slots and radial outer portions within selected others of the axial slots,
each of said radial inner portions of the phase windings being positioned within the corresponding axial slot radially inward from the radial outer portion of another one of the phase windings,
each of said radial outer portions of the phase windings being positioned within the corresponding axial slot radially outward from the radial inner portion of another one of the phase windings.

2. The three-phase electric motor assembly as claimed in claim 1, all of said phase windings including said radial inner portions and radial outer portions.

3. The three-phase electric motor assembly as claimed in claim 2,
each of said phase windings including full-slot portions within certain ones of the axial slots, with said certain ones of the axial slots being otherwise devoid of any of the other phase windings.

4. The three-phase electric motor assembly as claimed in claim 3,
said phase windings including the same number of radial inner portions,
said phase windings including the same number of radial outer portions,
said phase windings including the same number of full-slot portions.

5. The three-phase electric motor assembly as claimed in claim 2,
said radial outer portions of each phase winding including a first set thereof disposed in first slots with the radial inner portions of a first one of the other phase windings and a second set thereof disposed in second slots with the radial inner portions of a second one of the other phase windings,
said radial inner portions of each phase winding including a first set thereof disposed in first slots with the radial outer portions of a first one of the other phase windings and a second set thereof disposed in second slots with the radial outer portions of a second one of the other phase windings.

6. The three-phase electric motor assembly as claimed in claim 5,
said first and second sets of radial outer portions of each phase winding being equal in number,
said first and second sets of radial inner portions of each phase winding being equal in number.

7. The three-phase electric motor assembly as claimed in claim 1,
said selected and other axial slots each including only one of the radial inner portions and one of the radial outer portions therein.

8. The three-phase electric motor assembly as claimed in claim 1,
said phase windings cooperatively defining a generally concentric winding presenting leads configured for connection to a power source,
said concentric winding presenting a radially innermost margin and a radially outermost margin,
each of said phase windings being at least partly disposed along the radially innermost margin and at least partly along the radially outermost margin of the concentric winding.

9. The three-phase electric motor assembly as claimed in claim 8,
each of said phase windings presenting approximately one half thereof being disposed along or adjacent a respective one of each of the radial margins of the concentric winding.

10. The three-phase electric motor assembly as claimed in claim 1,
said portions of the phase windings received within the same axial slots being disposed substantially radially adjacent one another.

11. The three-phase electric motor assembly as claimed in claim 1,
said electric motor assembly comprising an induction motor.

12. The three-phase electric motor assembly as claimed in claim 11,
said phase windings cooperatively defining a 4-pole motor.

13. The three-phase electric motor assembly as claimed in claim 12,
said first phase winding defining an A-phase of the three-phase motor,
said second phase winding defining a C-phase of the three-phase motor,
said third phase winding defining a B-phase of the three-phase motor.

14. A method of assembling components for a three-phase electric motor, wherein the motor includes a stator core presenting circumferentially spaced axial slots and defining a central axial bore for receiving a rotor configured to rotate about an axis, said method comprising the steps of:
(a) inserting initial portions of a first phase winding and a second phase winding into selected ones of the axial slots, such that the initial portions cooperatively define a part of a radially outermost margin of a generally axially concentric winding;
(b) inserting a third phase winding into selected ones of the axial slots, at least some of the slots into which the third phase winding is inserted including the initial portions of the first and second phase windings, such that the portions of the third phase winding disposed in those slots are disposed radially inwardly from the initial portions of the first and second phase windings; and
(c) inserting remaining portions of the first phase winding and the second phase winding into selected others of the axial slots, such that the remaining portions cooperatively define a part of a radially innermost margin of the generally axially concentric winding.

15. The assembling method of claim 14,
step (c) including the step of disposing at least part of the remaining portion of the first phase winding within slots into which the third phase winding was inserted, substantially radially adjacent the third phase winding within such slots,
step (c) further including the step of disposing at least part of the remaining portion of the second phase winding within slots into which the third phase winding was inserted, substantially radially adjacent the third phase winding within such slots.

16. The assembling method of claim 15,
each of said initial portions of the first and second phase windings presenting approximately one half of the total of each of the respective phase windings.

17. The assembling method of claim 14,
said method steps being performed in chronological sequence from step (a) to step (c).

18. The assembling method of claim 17,
said inserting steps being performed by a mechanical device.

19. The assembling method of claim 18,
said electric motor comprising a 4-pole induction motor.

20. The assembling method of claim 19,
said first phase winding defining an A-phase of the three-phase motor,
said second phase winding defining a C-phase of the three-phase motor,
said third phase winding defining a B-phase of the three-phase motor.

21. A method of placing phase windings into a stator core for a three-phase electric motor to optimize impedance balancing, wherein the stator core presents circumferentially spaced axial slots and defines a central axial bore for receiving a rotor configured to rotate about an axis, said method comprising the steps of:
(a) inserting an initial portion of a first phase winding into selected ones of the axial slots, such that the initial portion of the first phase winding defines a part of a radially outermost margin of a generally axially concentric winding;
(b) inserting an initial portion of a second phase winding into selected others of the axial slots, such that the initial portion of the second phase winding defines another part of the radially outermost margin of the generally axially concentric winding;
(c) inserting an initial portion of a third phase winding into selected ones of the axial slots, such that at least some of the slots into which the initial portion of the third phase is inserted include one of the initial portion of the first phase winding and the initial portion of the second phase winding, to thereby define a part of a radially innermost margin of the generally axially concentric winding;
(d) inserting a remaining portion of the third phase winding into selected others of the axial slots, such that at least some of the slots into which the remaining portion of the third phase is inserted include the other of the initial portion of the first phase winding and the initial portion of the second phase winding, to thereby define another part of the radially innermost margin of the generally axially concentric winding;
(e) inserting a remaining portion of the first phase winding into selected ones of the axial slots, such that at least some of the slots into which the remaining portion of the first phase is inserted include the initial portion of the second phase winding, to thereby define another part of the radially innermost margin of the generally axially concentric winding; and
(f) inserting a remaining portion of the second phase winding into selected others of the axial slots, such that at least some of the slots into which the remaining portion of the second phase is inserted include the initial portion of the first phase winding, to thereby define another part of the radially innermost margin of the generally axially concentric winding.

22. The phase-winding placing method of claim 21,
said portions of the phase windings comprising coils that are graded from insertion step (a) to insertion step (f) to achieve a minimum end-turn package.

23. The phase-winding placing method of claim 22,
each of said initial portions of the phase windings presenting approximately one half of the total of each of the respective phase windings,
alternating initial and remaining halves of each of the phase windings being graded to yield balanced resistance at terminals.

24. The phase-winding placing method of claim 23,
said method steps being performed in chronological sequence from step (a) to step (f).

25. The phase-winding placing method of claim 24,
said inserting steps being performed by a mechanical device.

26. The phase-winding placing method of claim 25,
said electric motor comprising a 4-pole induction motor,
said first phase winding defining an A-phase of the three-phase motor,
said second phase winding defining a C-phase of the three-phase motor,
said third phase winding defining a B-phase of the three-phase motor.
